(19) United States
(12) Patent Application Publication
(10) Pub. No.: US 2005/0075866 A1
(43) Pub. Date: Apr. 7, 2005

(54) Speech enhancement in the presence of background noise

(76) Inventor: Bernard Widrow, Stanford, CA (US)

Correspondence Address: DORSEY & WHITNEY LLP;INTELLECTUAL PROPERTY DEPARTMENT, 4 EMBARCADERO CENTER, SUITE 3400, SAN FRANCISCO, CA, 94111, US

(21) Appl. No.: 10/952,604

(22) Filed: Sep. 28, 2004

Related U.S. Application Data
(60) Provisional application No. 60/509,315, filed on Oct. 6, 2003.

(51) Int. Cl. G10L 19/14

(52) U.S. Cl. 704/211

(57) ABSTRACT

This invention provides designs for systems that reduce or remove noise from noisy speech signals. These systems are based on adaptive predictors that can self-adjust to variations in speech signals within a fraction of the duration of a spoken word. Signal-to-noise ratio is improved, and speech intelligibility is enhanced. Detectability of human speech in noise is further increased by cascading two adaptive predictors, and removal of both periodic and wideband noise from noisy speech can be accomplished by cascading an adaptive narrowband noise canceller with an adaptive predictor. Applications are to hearing aids and hearing devices, and to speech communication systems that must work in noisy environments.

### RELATED APPLICATIONS

This application claims priority to Provisional Application Ser. No. 60/509,315 filed Oct. 6, 2003.

### FIELD OF THE INVENTION

This invention relates generally to the field of adaptive signal processing for human speech, particularly to the use of adaptive filters for the enhancement of speech signals against background noise.

### BACKGROUND OF THE INVENTION

The ability of a person to understand speech is greatly limited if background noise is present. A person with normal hearing can generally comprehend noisy speech as long as the power of the noise is less than the power of the speech signal. If the power of the noise is greater than that of the speech signal, the speech will not be understood. A person with hearing impairment is much more impacted by noise than a person with normal hearing. For most people with hearing loss, the slightest noise is enough to prevent speech understanding. The purpose of the present invention is to enhance speech signals in the presence of background noise, that is to reduce the noise amplitude while retaining the speech volume and intelligibility. Applications of the present invention will be to improvements in the design of hearing aids and hearing devices for people with hearing impairment, and to speech processing and communication equipment designed to deliver clear and understandable speech from noisy speech signals.

### OBJECTS AND SUMMARY OF THE INVENTION

It is an object of this invention to provide systems that reduce the noise of noisy speech signals while preserving the intelligibility of the speech. These systems take advantage of the differences that exist between human speech and additive noise. Speech is predictable over short periods of time, and noise, being wideband, is much less predictable. An adaptive predictor is used to separate speech and noise. The predictor is made to adapt rapidly in real time to the nuances of the speech.

Human speech is highly nonstationary from a statistical viewpoint. A speech predictor needs to be adaptive in order to adjust to the varying character of the speech signal. Rapid adaptation is necessary since substantial changes in the predictor need to take place during the time span of an individual spoken word.

The input signal to the adaptive predictor is noisy speech. The output signal is the speech, with the noise greatly attenuated. The speech is enhanced relative to the noise because it is much more predictable than the noise.

### BRIEF DESCRIPTION OF THE DRAWINGS

The foregoing and other objects of the invention will be more clearly understood from the following detailed description when read in conjunction with the accompanying drawings, wherein:

FIGS. 1A-1B show an adaptive filter of the type used with the invention, and a functional representation of it.

FIG. 2 is a block diagram of an adaptive predictor, in accord with the present invention.

FIG. 3 shows two adaptive predictors in a cascade connection.

FIG. 4 shows an adaptive periodic noise canceller in a cascade connection with an adaptive predictor.

### DESCRIPTION OF PREFERRED EMBODIMENT

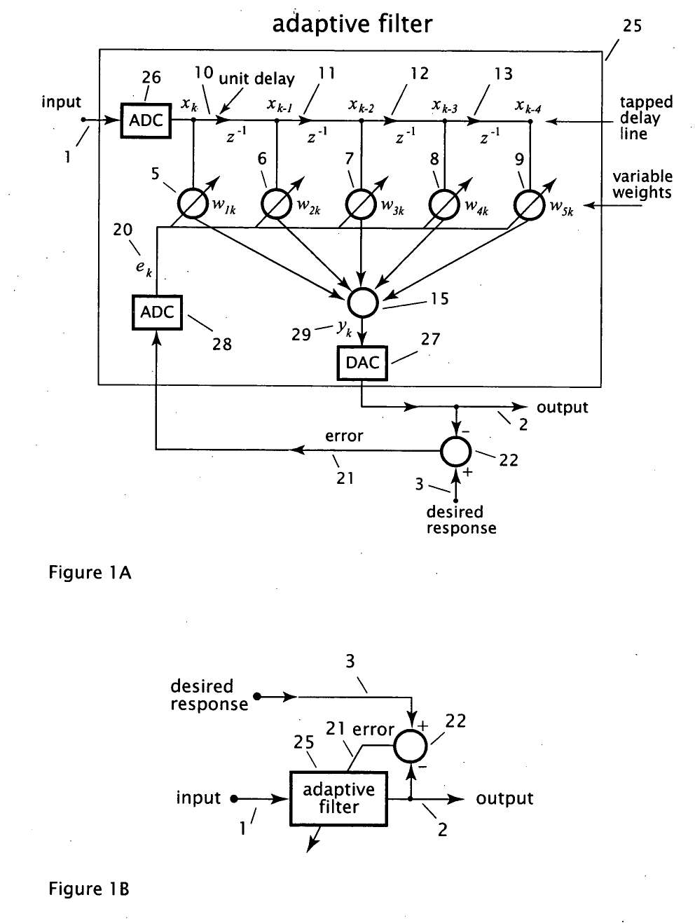

FIGS. 1A and 1B show an adaptive filter of the type used in the present invention. This filter has an input signal 1, an output signal 2, and a special input called the “error input” 21. The impulse response of the filter is variable. This impulse response is controlled by a set of variable coefficients or “weights”, w₁ₖ, 5, w₂, 6, . . . . The values of the weights, in turn, are controlled by an adaptive algorithm whose purpose is to find the best combination of weight values so that the mean square of the error is minimized. The weights are shown as circles, and the arrows through them represent their variability. In FIG. 1B, a functional diagram of the adaptive filter is shown, with an input and an output like a conventional filter, but with the special error input shown as an arrow through the adaptive filter indicating the variability of the filter with the purpose of minimizing the error.

Referring now to FIG. 1A, the input is digitized by an analog-to-digital converter (ADC) 26, and then fed to a tapped delay line. Unit delays are 10, 11, 12, . . . , and they are designated by z⁻¹, which is standard in the field of digital signal processing. The input signal at the first tap is xₖ, the signal at the second tap is xₖ₋₁, and so forth. The set of signals at all the taps is represented by the vector Xₖ.

$${X}_{k} = [ \begin{matrix}{x}_{k} \\ {x}_{k - 1} \\ ⋮ \\ {x}_{k - n + 1}\end{matrix} ]$$

These signals are multiplied by or weighted by the weights w₁ₖ,w₂ₖ, . . . . The weight vector is represented by:

$${W}_{k} = [ \begin{matrix}{w}_{1 k} \\ {w}_{2 k} \\ ⋮ \\ {w}_{nk}\end{matrix} ]$$

The number of weights is n. The ADC 26 samples the input regularly in time, and the time index or sample time number is k. The weighted signals are summed by the summer 15 to provide a weighted sum signal yₖ, 29. The weighted sum yₖ can be written as the inner product of the input signal vector and the weight vector. That is,
yₖ=Xₖ^{T}Wₖ
The filter output signal 2 is obtained from yₖ by digital-to-analog conversion, by DAC 27. The DAC includes an analog low pass filter, so that output 2 is a continuous signal. A desired response signal 3 is generally supplied as a training signal. Subtracting the filter output signal 2 from the desired response 3 gives an error signal 21 that is used by the adaptive algorithm to train or adapt the weights. The error signal 21 is digitized by ADC 28 to form the discrete error signal eₖ, 20 for the adaptive algorithm. The mean square of the error is known to be a quadratic function of the weights. This function has a global minimum and no local minima. The method of steepest descent is generally used to iteratively find the global optimum.

The most widely used adaptive algorithm in the world is the LMS algorithm of Widrow and Hoff (see B. Widrow and S. D. Stearns, “Adaptive Signal Processing”, New Jersey: Prentice-Hall, Inc., 1985, incorporated herein by reference). This algorithm was invented in 1959 and patented by B. Widrow and M. E. Hoff, Jr. under U.S. Pat. No. 3,222,654. LMS is an iterative algorithm based on the method of steepest descent, and it is given by
Wₖ₊₁=Wₖ+2μeₖXₖ
where
eₖ=dₖ−yₖ.

The parameter μ is chosen to control rate of convergence and stability. When μ has a small value, convergence is slow and this algorithm causes the weight vector to converge in the mean to a Wiener solution, the best linear least squares solution W*, given by
W*=R⁻¹P
where
R=E[xₖxₖ^{T}]
and
P=E[dₖxₖ^{T}]
The parameter μ is chosen to control rate of convergence and stability. When μ has a small value, convergence is slow and this algorithm causes the weight vector to converge in the mean to a Wiener solution, the best linear least squares solution W*, given by
W*=R⁻¹P
where
R=E[xₖxₖ^{T}]
and
P=E[dₖxₖ^{T}]
The algorithm is stable as long as 1>μ trace R>0. This is the condition for convergence of the variance of the weight vector. Various proofs of convergence and formulas for speed of convergence are given in the literature. Typical convergence time of an adaptive filter with μ chosen so that μ trace R=0.1 would be a number of sample periods equal to ten times the number of weights n, or about ten times the length of the filter impulse response. This rate of convergence would be suitable for the adaptive filter used with this invention.

Many algorithms other than LMS exist for adapting the weights and can be used with the present invention. The literature is extensive. An excellent summary is given by S. Hay-kin, “Adaptive Filter Theory”, Third Edition, Prentice-Hall, Englewood Cliffs, N.J., 1996, incorporated herein by reference. This book describes the recursive least squares algorithm (RLS) which is often used to adapt an adaptive filter having either a tapped delay line or a lattice architecture.

The adaptive filter of FIG. 1B has an analog interface in that it accepts an analog (continuous) input 1, and produces an analog (continuous) output 2. The adaptive filter of FIG. 1A converts the analog input into digital form, and converts its digital output yₖ, 29, into analog form. The sampling rate of the adaptive filter should be the Nyquist rate, or preferably several times that, for the signals flowing through it. The filter of FIG. 1A could be built to directly accept an analog input however, and then the ADC's 26, and 28, and DAC 27 could be eliminated. The tapped delay line could be an analog delay line. An example is a surface acoustic wave device (SAW). The LMS algorithm can be implemented in continuous form. A way to do this is shown in B. Widrow et al., “Adaptive Antennas Systems”, Proceedings of the IEEE, Vol. 55, No. 12, December, 1967, pp 2143-2159, incorporated herein by reference. The analog form of the LMS algorithm is illustrated in FIGS. 7 and 8, page 2149, of this reference.

An analog-input analog-output type of adaptive filter is desirable for inclusion in most of the circuits of the present invention. If, however, the input to the adaptive filter is already in digital form, and a digital output is desired, then ADC's 26 and 28 and DAC 27 can be eliminated. The sampling rate of the data signals flowing through the adaptive filter would need to be synchronized with the clock rate of the adaptive filter itself, however.

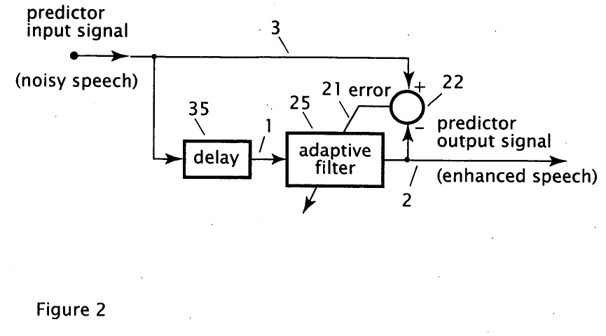

The adaptive filter of FIGS. 1A and 1B is a key building block of the adaptive predictor. FIG. 2 is a block diagram of an adaptive predictor, in accord with the present invention.

In FIG. 2, the adaptive filter 25 has an input signal 1, and it produces an output signal 2. Its error signal 21 is obtained as the difference between the desired response 3 and the adaptive filter output 2. The desired response 3 is the predictor input signal itself. The adaptive filter input 1 is obtained from the predictor input signal 3 delayed Δ units of time by the delay 35.

The adaptive predictor is described in the Widrow and Stearns book, Chapter 12. FIG. 12.36 of this book shows the adaptive predictor as it would be used to separate wideband noise from a noisy periodic signal. This invention uses the adaptive predictor to separate wideband noise from a noisy speech signal. Human speech is of course very different from a periodic signal. These two applications of the adaptive predictor differ in how the adaptive filter is used and how the predictor is configured.

A periodic signal is perfectly predictable. Its statistical properties are stable or stationary over time. Human speech, on the other hand, is not perfectly predictable and its statistical properties are highly nonstationary. Human speech is able to be predicted over a short time, not perfectly, but to a good approximation. The further into the future one tries to predict it, the poorer will be the approximation. In the case of a periodic signal, one can predict perfectly as far into the future as desired. Wideband noise, in contrast to a periodic signal and to human speech, is essentially unpredictable. It can be approximately predicted by an amount of time into the future equal to the reciprocal of its bandwidth. Noise with a large bandwidth can only be predicted over a very short time into the future. Prediction is therefore a mechanism for the separation of periodic signals and separation of speech signals from wideband additive noise. When using a predictor for separation of signals from background noise, one must choose how far into the future the predictor should predict. For the adaptive predictor of FIG. 2, the delay time of the delay 35 determines the amount of time into the future that prediction is made.

The adaptive predictor functions in the following way. To make the error 21 small, which is accomplished by the adaptive algorithm in the adaptive filter, it is necessary for the adaptive filter 25 cascaded with the delay 35 to produce an output signal 2 which is close to the predictor input signal 3. This corresponds to the adaptive filter and the delay 35 having a combined transfer characteristic like a gain of unity. For this to be, the adaptive filter would need to reverse the effects of the delay, ie to create an output 2 which is a predicted version of the adaptive filter input 1. The prediction would be Δ units of time into the future, an amount of time equal to the delay time.

The above is an intuitive explanation of the functioning of the adaptive predictor. A mathematical analysis of the predictor with noisy periodic inputs is given in the Widrow and Steams book. No mathematical analysis yet exists for the behavior of the adaptive predictor with noisy speech inputs.

For speech enhancement, the delay 35 should be chosen to be long enough to make the noise contained in the filter input signal 1 be decorrelated from the noise contained in the desired response signal 3. A good choice of delay would be several times the reciprocal of the noise bandwidth. With a sampling rate of 22 kHz in the adaptive filter, for example, a typical choice of delay would be from 1 to 20 sampling periods. A good choice of number of weights for the adaptive filter would be from 64 to 512. A good choice for parameter μ would be such that μ trace R would range from 0.05 to 0.25. Parameter choices within the given ranges are not critical. Good performance is obtained within these ranges for a wide variety of input signal to noise ratios.

With μ trace R set to 0.1, substantial variation takes place in the weights (in the impulse response) of the adaptive filter during the time period of an individual spoken word. This variation is the key to speech enhancement. Experiments were tried using optimal weight settings for best least squares prediction for phrases of noisy speech. The Wiener solution was obtained, which gave a set of weights that did the best prediction averaged over a given phrase. When the weights were fixed at the Wiener solution and the noisy speech phrase was played through the predictor, the output was as noisy as the input. But when the noisy speech was played through the adaptive predictor that was free to adapt to the speech in real time, substantial noise reduction was experienced. What is needed for speech enhancement is adaptive filtering that provides short-term nonstationary Wiener solutions that vary as the words are spoken. These solutions are obtained in real time by the adaptive predictor of FIG. 2 whose adaptive filter is capable of rapid adaptation.

The adaptive predictor has been used in the past to enhance periodic signals against wideband additive noise. For this purpose, the adaptive filter is used to obtain long-term Wiener solutions. This is done by making μ trace R much smaller, generally less than 0.01. Speech enhancement requires much faster adaptation. This is critically important for speech enhancement.

This invention represents a new idea for speech enhancement in the presence of background noise, and it is based on fast adaptive prediction. In the adaptive predictor, the adaptive filter acts as a least-squares statistical predictor of its input signal, predicting Δ units of time into the future. The output signal contains the predictable components of the input signal. An input signal composed of speech and additive uncorrelated noise would have a relatively unpredictable component, the noise, and a much more predictable component, the speech. The noise would be blocked by the adaptive filter, and the speech would propagate through it, with a small amount of distortion. Experiments have been done which show that when the input is speech without noise, the output is speech with essentially no distortion. When the input SNR is 0 dB (speech and noise having equal powers), the speech is intelligible at the input only if one listens carefully, but the speech is easily understood at the predictor output. The output speech signal is at the same amplitude as the input speech signal but the noise is almost gone. When the input SNR is −10 dB, the noise is so great that one is barely aware that someone is speaking when listening to the input, but one can detect speech and even understand what is being said when listening to the predictor output. When the input SNR is −20 dB, one cannot detect speech when listening to the input, but it is easy to detect speech and even understand some of the words at the predictor output.

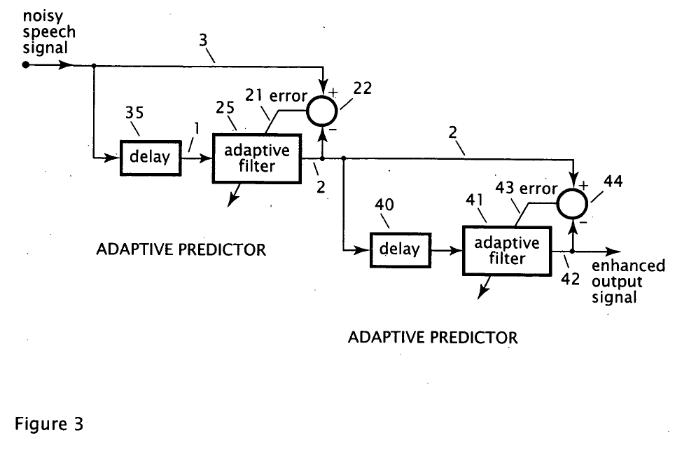

Further enhancement of speech against background noise can be made with the system diagrammed in FIG. 3. This system is comprised of two adaptive predictors in a cascade connection. The output 2 of the first predictor is the input to the second predictor. The parameters of the second predictor, choice of the delay Δ, the choice of μ, and the choice of numbers of adaptive weights could be the same as for the first predictor, or they could be independently chosen. This system has been tested and further noise reduction has been observed. However, some distortion of the speech has also been observed. For input signals 3 with poor signal-to-noise ratios, of the order of −20 dB, intelligibility of speech at the output 42 is helped by noise reduction but hindered by speech distortion. When listening to the signal at output 42, it is easier to detect the presence of human speech than at output 2. Thus, the purpose of the cascaded predictors is to improve the detectability of human speech in noise. More than two predictors could be cascaded for further speech enhancement.

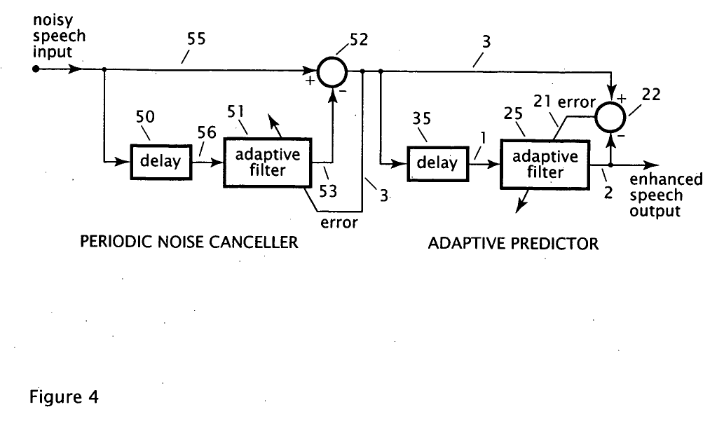

Sometimes the noise of noisy speech contains periodic as well as broadband components. The adaptive predictor of FIG. 2 would then enhance the periodic noise components as well as the speech signal. This would be highly undesirable. An example of where this would happen would be listening in a room with air conditioning ducts that emit fan noise as well as turbulence noise. Another example would be listening in a motor vehicle when periodic engine noise mixes with wideband tire noise and airflow noise. The system of FIG. 4 is designed to prevent the enhancement of periodic noise components.

FIG. 4 shows an adaptive canceller of periodic noise cascaded with the adaptive predictor of FIG. 2. The periodic noise canceller is described and analyzed in the Widrow and Stearns book, Chapter 12, and is illustrated in FIG. 12.34 of this reference. It uses the same principles of adaptive prediction, but in a different way. It cancels the predictable components of its input and outputs the unpredictable components.

In order to prevent the canceller frrm canceling speech signals along with the periodic noise, it is necessary to make the delay 50 long enough to insure that speech components at the adaptive filter input 56 are not correlated with the speech components of the input signal 55. A delay 50 of several seconds or more will do this. Such a delay will not decorrelate the periodic noise components of 56 from those of 55, and the periodic noise will be canceled. The periodic noise canceller works like a notch filter, automatically making notches at the fundamental and harmonic frequencies of the periodic noise. When operating at 22 kHz, with a noise canceller having 1024 weights, its adaptive filter has an impulse response duration of 0.0467 sec. When forming a notch, the notch width is the reciprocal of the impulse response duration, or 21.4 Hz. As the notches developed by the noise canceller to cancel the periodic noise are 21.4 Hz wide, the notches do not significantly harm the spectrum of the speech signal that has a bandwidth of about 200 times that of a single notch. The adaptive canceller works well and does not significantly distort the speech signal.

Signal 3 is comprised of wideband noise plus speech. The adaptive predictor reduces or removes the wideband noise and the result is that the output 2 is enhanced speech.

In the cascade of the periodic noise canceller and adaptive predictor shown in FIG. 4, the objective is to reduce or eliminate both wideband and periodic noise from a noisy speech signal. It should be noted that this same objective could be achieved by reversing the order of the cascade, with the predictor first, then the periodic noise canceller. This does work, but the order of the cascade shown in FIG. 4 is preferable.

All of the methods described above for enhancement of speech against additive noise can be used to improve the performance of hearing aids. The adaptive system shown in FIGS. 2, 3, or 4 could be implemented digitally and could be enclosed within the shell of a hearing aid. These systems could be inserted anywhere along the signal path from microphone output to input of the final power amplifier that drives the loudspeaker. It would be preferable to incorporate the speech enhancement at the microphone output, so that less noise would be present at the input to the compression and frequency-shaping circuits. The speech enhancing system of FIG. 4 may provide an additional benefit, and that is feedback suppression. An oscillation caused by feedback would be cancelled by the periodic noise canceller.

The speech enhancement methods described above could also be used to improve the performance of cellular phones when used in a noisy environment such as in an automobile, a restaurant, or outdoors when windy. The speech enhancing system could be incorporated within the cell phone housing and could be connected anywhere between the microphone output and the input to the modulator. This will make it easier for the person of the opposite end of the call to be able to understand what is being said under noisy circumstances. The same methodology could be used to improve speech quality with computer microphones, conference room microphones, news reporting microphones, etc.

The above description is based on preferred embodiments of the present invention; however, it will be apparent that modifications and variations thereof could be effected by one with skill in the art without departing from the spirit or scope of the invention, which is to be determined by the following claims.

1. A system for enhancing an input signal having speech in the presence of noise comprising an adaptive predictor that self-adjusts to variations in speech signals within a fraction of the duration of a spoken word.

2. A system for enhancing an input signal having speech in the presence of noise comprising a delay unit for outputting a delayed version of said input signal comprising:
an adaptive filter for receiving the delayed version of said input signal, and
an adder connected to said adaptive filter for subtracting the output signal of said adaptive filter from the said input signal to provide an error signal to said adaptive filter for adaptation,
said adaptive filter configured to store an adaptive algorithm capable of very rapid adaptation for the purpose of minimization of the mean square of said error signal with the output signal of said adaptive filter provided as the system output containing speech plus greatly reduced noise.

3. The system of claim 2, wherein said input signal is digital, said output signal is digital, said delay unit is implemented digitally, said adaptive filter is implemented in digital form, having a digital input signal, a digital error signal, a digital output signal, and having a sampling frequency synchronized to that of the said input signal.

4. A system for reducing or removing wideband noise from noisy speech signals comprising two or more adaptive predictors, each of said predictors capable of self-adjustment to variations in speech signals within a fraction of the duration of a spoken word.

5. A system for enhancing an input signal having speech in the presence of noise comprising:
a first adaptive predictor whose input is said input signal and providing an output signal, and
a second adaptive predictor whose input signal is the output signal of said first additive predictor,
the output signal of said second adaptive predictor containing speech plus greatly reduced noise.

6. A system for reducing or removing noise from noisy speech signals comprising:
an input signal source containing human speech and additive wideband and periodic noise,
an adaptive narrowband noise canceller whose input signal is derived from said input signal source, and
an adaptive predictor whose input signal is derived from the output of said adaptive narrowband noise canceller, the output signal of said adaptive predictor containing speech plus greatly reduced noise.
